(19) United States
(12) Patent Application Publication
(10) Pub. No.: US 2006/0095422 A1
(43) Pub. Date: May 4, 2006

(54) Method of managing access to Web pages and system of managing access to web pages

(76) Inventor: Katsuro Kikuchi, Hachioji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/253,828

(22) Filed: Oct. 20, 2005

(30) Foreign Application Priority Data
Oct. 22, 2004 (JP) 2004-307588

(51) Int. Cl. G06F 17/30

(52) U.S. Cl. 707/3

(57) ABSTRACT

There is provided a method of efficiently accessing information located on Web pages in a ubiquitous environment such as a home, an office and on a travel. A gateway server is located between a client and Web servers for providing the contents. The gateway server traps a request of a browser operating in the client and records an access history. On the access records, the display form of a link in the contents is changed, and the service of managing the accessed information is presented to the client. Further, the user may optionally set an attribute to the contents and change the display form of the accessed link according to the set attribute.

### INCORPORATION BY REFERENCE

The present application claims priority from Japanese application JP 2004-307588 filed on Oct. 22, 2004, the content of which is hereby incorporated by reference into this application.

### BACKGROUND OF THE INVENTION

1. Field of the Invention

The present invention relates to a method of managing access to Web pages, more specifically relates to a method of managing access to web pages based on access history.

2. Description of the Related Art

Many kinds of massive information are made open on the Web pages whether or not those pieces of information are useful or useless, so that the Web pages are likely to have an important role as obtaining information. In actual, however, unarranged pieces of information are flooding on the Web pages so that a person may have difficulty in accessing a piece of necessary information. For overcoming this difficulty, a person may use a Web search engine such as Yahoo or Google so that the person may efficiently reach the useful information. This may be realized by using a bookmark feature provided in a browser.

Further, by checking if the Web page has been already accessed, it is possible to avoid wasteful access to the already watched Web. For example, the Web mail system such as Yahoo! Mail has a feature of managing the read mail contents, so that the user does not need to check the once-read contents, that is, the once-read mail twice or more. Turning to the Web browser, the Web browser has a feature of managing an access history though it is quite simple. The Web browser stores the reached URLs as a history so that the browser may distinguish the accessed links (URLs) from the unaccessed links (URLs) when displaying the contents.

This kind of history feature is disclosed in the Official Gazettes of JP-A-2001-297048 and JP-A-2003-337737.

### SUMMARY OF THE INVENTION

As described above, as a means of searching useful information from a massive amount of information on the Web, a Web search engine is quite useful. However, for selecting a retrieval keyword, some kind of knack is required. Moreover, the information on the Web is so massive that the retrieved result may include unnecessary pieces of information (URLs), which becomes an obstacle to efficient collection of the target information. Turning to the bookmark feature of the browser, it is necessary to take a lot of trouble for doing maintenance of bookmarks such as a shared topic of bookmarks in a plurality of clients such as a home, an office or a mobile environment. The feature of managing the read data, presented by the application such as the Web mail, is performed properly to the user. However, the feature does not manage the other contents rather than the contents managed by the application itself as the read data. This feature thus does not make contribution to improving access to the contents on the overall Web.

The Web access history feature provided in the browser is meaningless if the feature is used in a plurality of clients such as a home and an office because the Web browser stores an access history as a local page. Further, the feature of managing the history is served to merely distinguish the accessed pages from the unaccessed ones on the display irrespective of the usefulness and the attribute of the contents. Hence, this feature has difficulty in improving the efficiency of searching the target information. Moreover, the terminal service feature of the Windows (trademark) 200 Server may be used for utilizing the simple desktop environment, that is, keeping the Web browser the same. However, this does not make so much contribution to improving the access efficiency in a respect of the network promotion when the feature is used inside or outside the office and in a respect that the Web browser realizes a simple management of an access history.

It is an object of the present invention to provide a method of managing access to Web pages which method is arranged to provide a service of managing the accessed information by generically managing the accessed information through a gateway server so that a user may efficiently access any Web page.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating the most fundamental system composition of managing access to Web pages according to one embodiment of the present invention;

FIG. 2 is a diagram showing a table of a user management database included in the most fundamental system composition of managing access to Web pages according to one embodiment of the present invention;

FIG. 3 is a diagram showing a table of an access history database included in the most fundamental system composition of managing access to Web pages according to one embodiment of the present invention;

FIG. 4 is a diagram showing a table of a conversion rule database included in the most fundamental system composition of managing access to Web pages according to one embodiment of the present invention;

FIG. 5 is a sequence view showing the process among a client, a gateway server and a Web server included in the most fundamental system composition of managing access to Web pages according to one embodiment of the present invention;

FIG. 6 is a view showing a processing flow of converting contents included in the most fundamental system composition of managing access to Web pages according to one embodiment of the present invention;

FIG. 7 is a block diagram showing the composition in which a plurality of clients exist;

FIG. 8 is a sequence view showing a process among a client, a gateway server and a Web server in one embodiment in which the gateway server rewrites a URL;

FIG. 9 is a view showing a login screen of the gateway server included in one embodiment in which the gateway server rewrites a URL;

FIG. 10 is a view showing a portal screen of a service of managing access to Web pages included in one embodiment in which the gateway server rewrites a URL;

FIG. 11 shows a HTML fragment of a portal screen of a service of managing access to Web pages included in one embodiment in which the gateway server rewrites a URL;

FIG. 12 is a view showing a flow of converting contents included in one embodiment in which the gateway server rewrites a URL;

FIG. 13 shows the exemplary rewritten URL in one embodiment in which the gateway server rewrites a URL;

FIG. 14 is a block diagram showing a system composition of managing access to Web pages in one embodiment in which a feature of updating and detecting contents is included;

FIG. 15 is a diagram showing a table of a contents update database included in one embodiment in which a feature of updating and detecting contents is included;

FIG. 16 is a view showing a flow of checking an update time of contents included in one embodiment in which a feature of updating and detecting contents is included;

FIG. 17 is a view showing a table of an access history database included in one embodiment in which a feature of updating and detecting contents is included;

FIG. 18 is a view showing a table of a conversion rule database included in one embodiment in which a feature of updating and detecting contents is included;

FIG. 19 is a sequence view showing a process among a client, a gateway server and a Web server included in one embodiment in which a feature of updating and detecting contents is included;

FIG. 20 is a view of a flow of converting contents included in one embodiment in which a feature of updating and detecting contents is included;

FIG. 21 is a view showing a table of a database for defining a display name of attribute to be set to an attribute ID included in one embodiment in which a feature of setting an attribute of contents is included;

FIG. 22 is a view showing an interface on which a display name of attribute is to be set included in one embodiment in which a feature of setting an attribute of contents is included;

FIG. 23 is a view showing a table of a database for storing correspondences between URLs and attribute IDs included in one embodiment in which a feature of setting an attribute of contents is included;

FIG. 24 is a view showing an interface on which an attribute to contents (URL) is set included in one embodiment in which a feature of setting an attribute of contents is included;

FIG. 25 is a view showing a HTML fragment of an exemplary interface on which an attribute to contents (URL) is set included in one embodiment in which a feature of setting an attribute of contents is included;

FIG. 26 is a view showing an exemplary interface on which an attribute to partial URL is set included in one embodiment in which a feature of setting an attribute of contents is included;

FIG. 27 is a view showing a table of a conversion rule database included in one embodiment in which a feature of setting an attribute of contents is included;

FIG. 28 is a view showing an exemplary interface on which a display style is to be set included in one embodiment in which a feature of setting an attribute of contents is included;

FIG. 29 shows one example of another notation URL included in one embodiment in which a feature of corresponding one URL notation with another URL notation is included;

FIG. 30 shows a process of normalizing a URL included in one embodiment in which a feature of corresponding one URL notation with another one is included;

FIG. 31 shows an exemplary interface on which a process of canceling another notation is to be set included in one embodiment in which a feature of corresponding one URL notation with another one is included; and

FIG. 32 shows an exemplary interface for checking if the UR has been read included in one embodiment in which a feature of checking if another user has already read the Web page is included.

### DESCRIPTION OF THE EMBODIMENTS

### First Embodiment

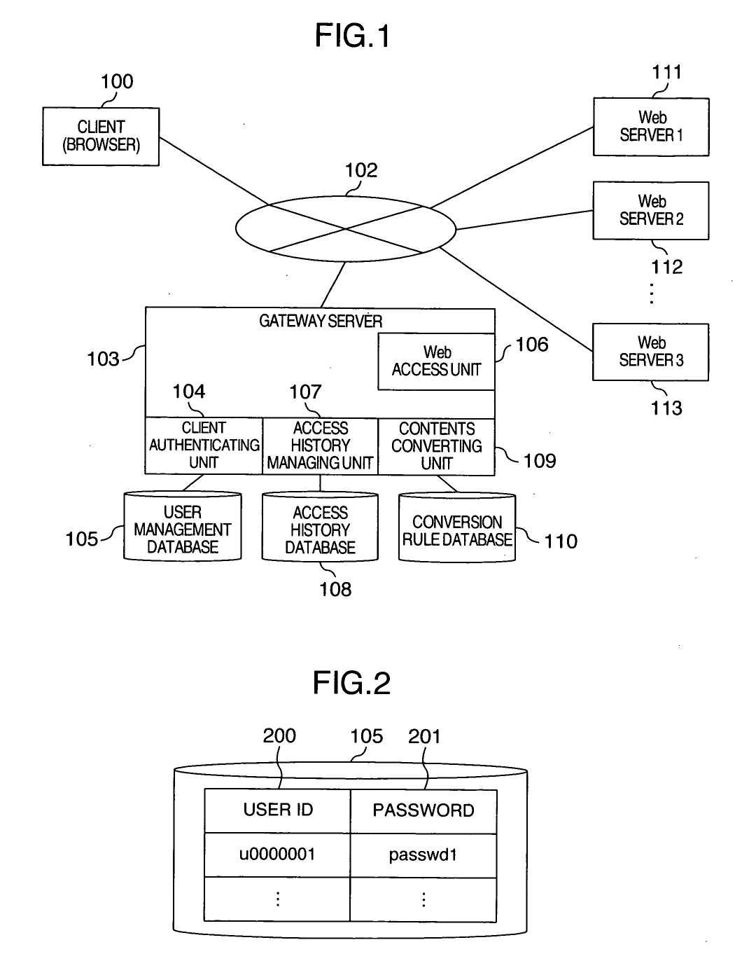

The description will be turned to the first embodiment of the present invention. FIG. 1 illustrates the system composition. A gateway server 103 that manages the accessed Web pages is located between a client 100 and Web servers 111 to 113. For managing access to Web pages, a user sets to the gateway server 103 a proxy server of a Web browser that corresponds to the client 100. This setting allows all the Web accesses to be done by the client 100 to be relayed through the gateway server 103. This makes it possible for the user to accept a service of managing access to Web pages.

The gateway server 103 is made up of a client authenticating unit 104, a user management database 105, a Web access unit 106, an access history managing unit 107, a contents converting unit 109, and a conversion rule database 110. The client authenticating unit 104 operates to authenticate the client 100 as a user. The Web access unit 106 accesses the Web server as a proxy server in place of the client 100 for obtaining the contents from the Web server. The access history managing unit 107 stores a Web access history of the client 100. The contents converting unit 109 changes the display form of a access history database 108 and accessed link.

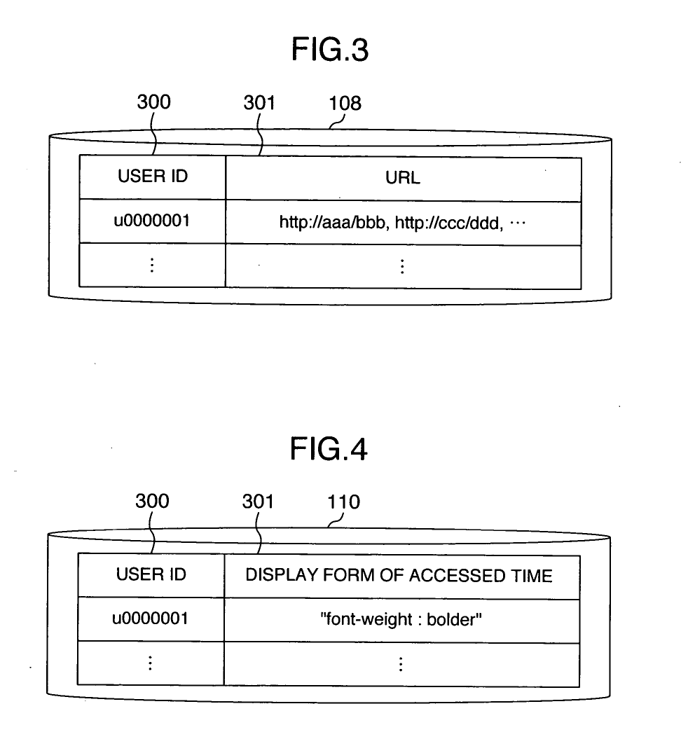

In turn, a table composition of the database will be described with reference to FIGS. 2 to 4. The user management database 105 includes a user ID 200 and a password 201 as the information for authenticating the client 100. The access history database 108 stores an accessed URL for each user. In this database, the user ID 300 is a corresponding field with the user ID 200 of the user management database 105. The conversion rule database 110 stores the display form of the accessed URL for each user. In this embodiment, the display form is specified by the CSS (Cascading Style Sheets). Instead, it is possible to use the Dynamic HTML technique as the display form so that a tool chip may be outputted.

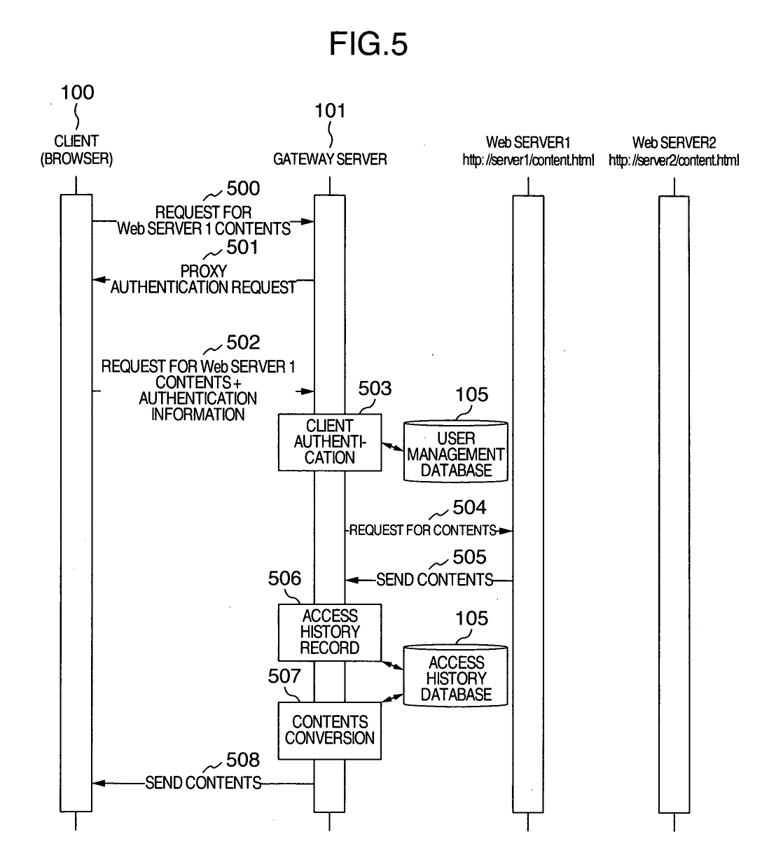

In turn, the flow of process will be described with reference to FIG. 5. At first, the client 100 issues a request for http://server1/content.html to the Web server 1 (111) as a request for contents (500). Since the gateway server 103 is set as the proxy server of the client 100, this request is sent to the gateway server 103. At the initial access after the browser is started, the Web access unit 106 of the gateway server 103 sends the request for proxy authentication to the client 100 (501). After the request for proxy authentication is recieved, the client 100 is supplied with a user ID and a password required for proxy authentication by a user. After the user ID and the password are accepted, the client 100 issues a request for contents to the gateway server 103 again (502). In response to the request, the client authenticating unit 104 of the gateway server picks the proxy authentication information out of the HTTP header and then performs the user authentication on the information (503). As the method of authenticating the user, the matching between the user ID and the password is executed through the use of the user management database 105. Then, the Web access unit 106 of the gateway server 103 obtains the contents having been requested by the client from the Web server 1 (504, 505). Next, the access history management unit 107 checks if the obtained contents correspond to the accessed URL by referring to the access history database 105 and, if the contents do not correspond to the accessed URL, records the contents of the URL in the access history database 105 as the access history (506). As a result of reference, if it is checked that the obtained contents correspond to the accessed URL, the contents converting unit 109 converts the contents so that the access information may be buried in the contents obtained from the Web server 1 (507).

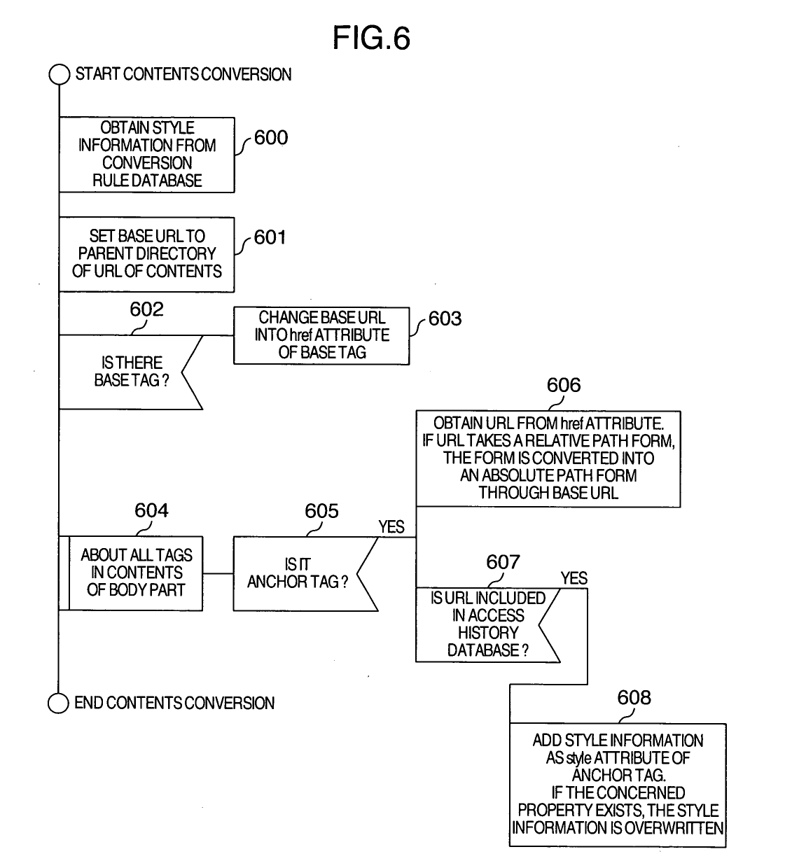

The process of converting the contents will be described in detail with reference to FIG. 6. At first, the display form of the accessed link is obtained from the conversion rule database 110 (600). Next, as a base URL for converting the relative URL of the contents into an absolute URL, the process is executed to set a parent directory of the URL of the obtained contents (601). However, if a BASE tag is included in the contents, the base URL is changed into the URL specified by a href attribute of the BASE tag (603). Next, about all the A tags in a BODY tag of the contents, the conversion of the display form of the link is executed (604, 605). At first, the URL is extracted from the href attribute of the A tag. If the URL takes a relative path form, the relative path form URL is converted into the absolute path form URL based on the base URL (606). Then, it is checked if the extracted URL is included in the access history database 105 (607). If it is included, the CSS information obtained in the step 600 is added to the style attribute of the A tag. If the property matched to the CSS information has been already included, the CSS information is overwritten on the style attribute of the A tag (608). These series of processes result in having converted the display form of the URL located in the access history database 105 and included in the URLs of the contents, that is, the accessed URL into the display form specified by the conversion rule database 110.

The gateway server 103 sends the contents to the client 100 after this conversion is carried out. The browser of the client 100 having recieved the contents shapes the contents according to the display form (CSS) of the accessed URL and shows the shaped contents to the user. This allows the user to check if the contents are the accessed contents. Later, if the user clicks the link included in the contents, the process from the steps 502 to 508 is executed so that the contents on which the accessed information is reflected are shown to the user.

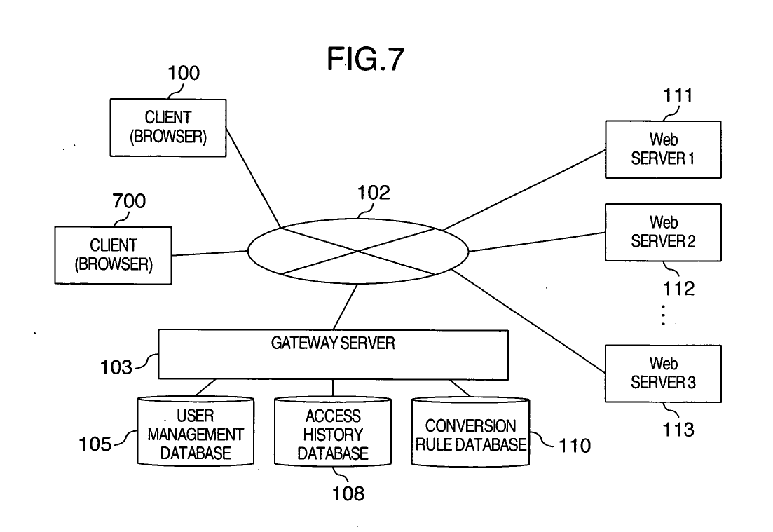

In a case that the user uses the client 700 in a different environment from the client 100 as shown in FIG. 7, the gateway server 103 enables to determine that the clients 700 and 100 are the same user by the user authentication of the steps 500 to 502 shown in FIG. 5. This makes it possible to present the user with the transparent service of managing the accessed URLs in various environments such as a home, an office, and a business-trip destination.

### Second Embodiment

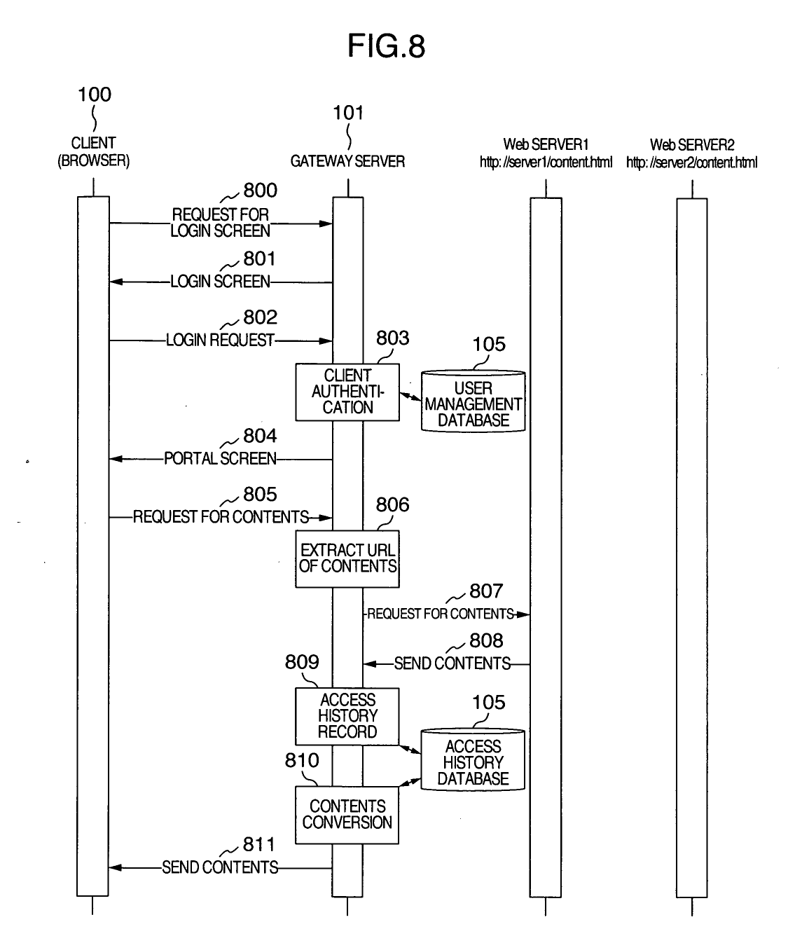

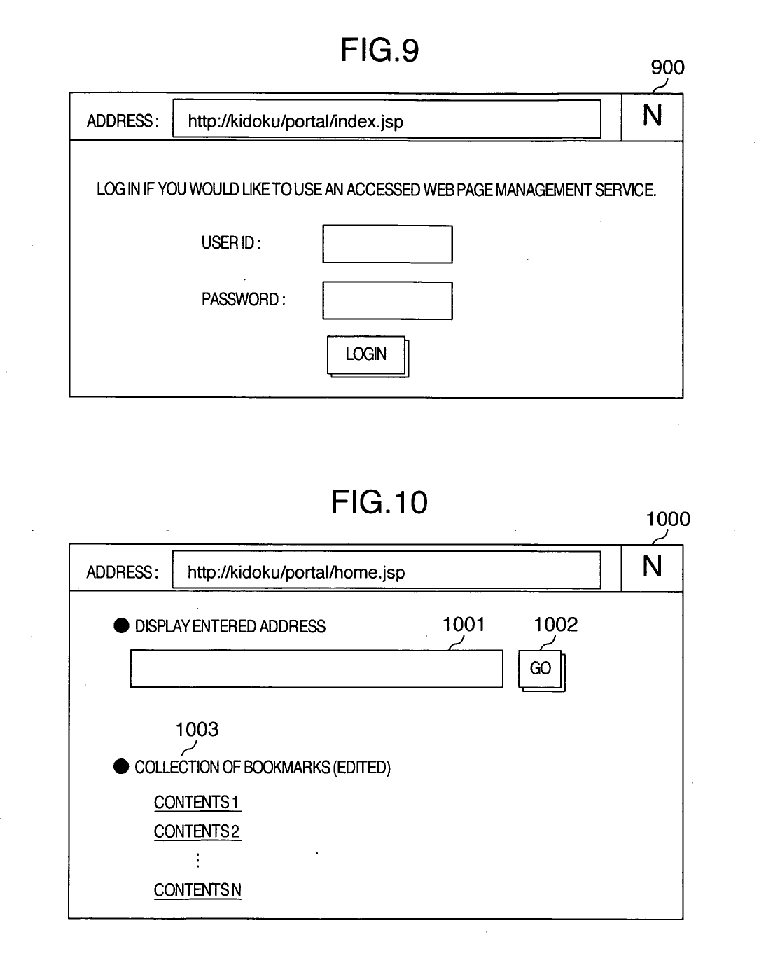

The foregoing first embodiment realizes the service of managing the accessed URLs by setting the proxy of the Web browser to the gateway server. On the other hand, for the browser provided in the cellular phone, in general, it is impossible to change the proxy setting. The embodiment of the service of managing the accessed URLs in the Web browser having no proxy feature will be described with reference to FIGS. 8 to 13. The system composition is the same as that shown in FIG. 1 or 7. FIG. 8 shows the sequence of the process. For this embodiment, at first, the browser explicitly accesses the gateway server 103 for logging in the gateway server 103 (800 to 803). When the browser accesses the gateway server 103, the login screen as shown in FIG. 9 is prompted to the client 100 (800, 801). In this embodiment, the Form-authenticated login screen is prompted to the client 100. Like the proxy authentication of the foregoing embodiment, the user enters a user ID and a password for being authenticated by the gateway server 103 (803). Though the Form-authentication is executed in this embodiment, the Basic authentication may be used as well. When the user is authenticated in the gateway server 103, the portal screen 1000 for the service of managing the accessed URLs is displayed (804). The portal screen 1000 is composed of two parts, that is, an address input area 1001 on which the user directly inputs a URL and a bookmark collection 1003 in which the user pre-registers the frequently used URLs.

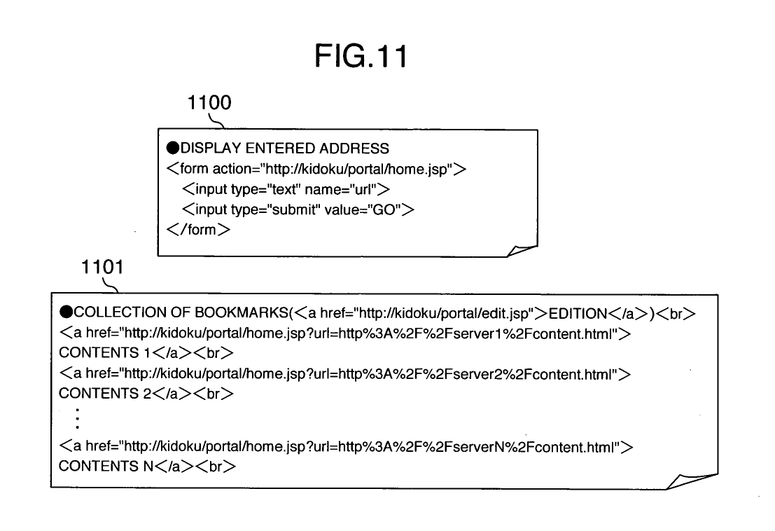

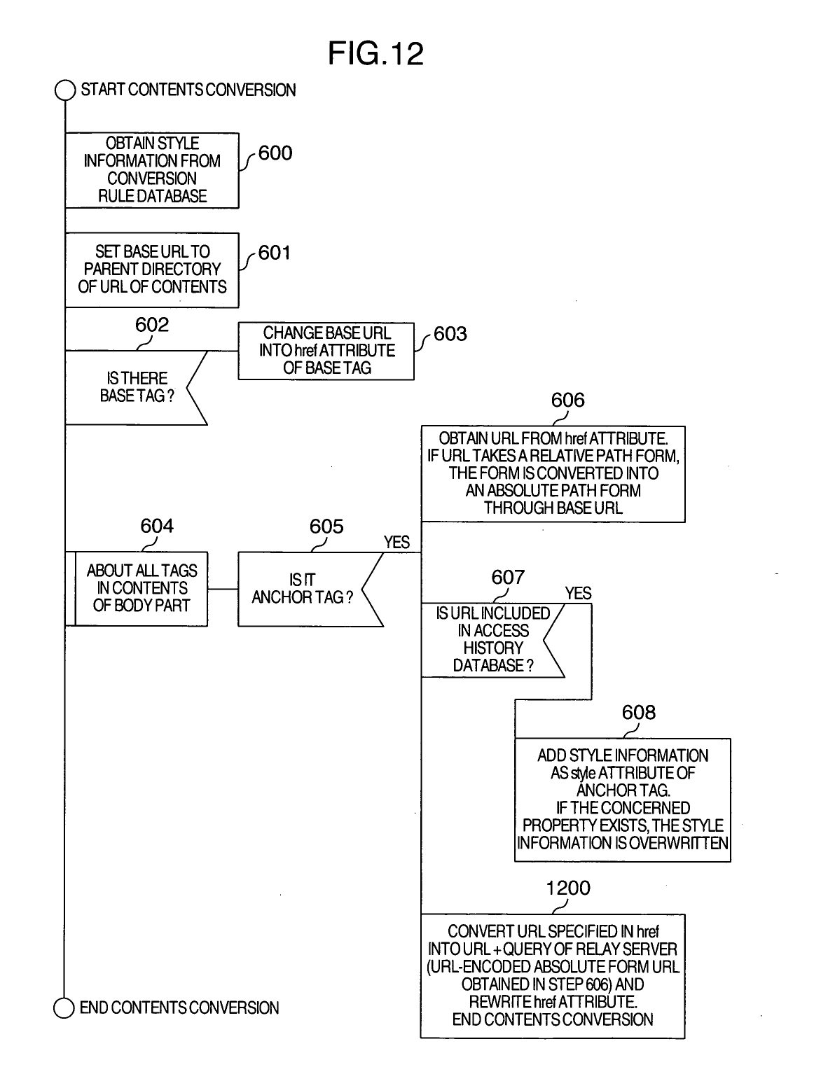

The HTML of each contents fragment is shown in FIG. 11. As indicated in the concerned HTML (1101) of FIG. 11, the link of the bookmark collection takes a form of URL+query of the gateway server 103. The query is composed of a value properly encoded for burying the actual URL as a query. In this embodiment, the URL encode is used as the encoding method. When the user inputs a URL in the address input area 1001 and presses a GO button 1002, this URL is notified as the query to the gateway server 103. Likewise, when the user clicks the URL of the bookmark collection 1003, the URL of the contents is notified to the gateway server 103 ((805). The gateway server 103 extracts the URL of the contents from the request given by the client (806). Then, the gateway server 103 actually accesses the server for obtaining the contents (807, 808). Next, the URL is recorded in the access history database 105 (809). Then, the contents conversion (810) is carried out and then the contents are returned to the client 100 (811). The method of converting the contents is shown in FIG. 12. At first, the display form of the accessed link is obtained from the conversion rule database 110 (600).

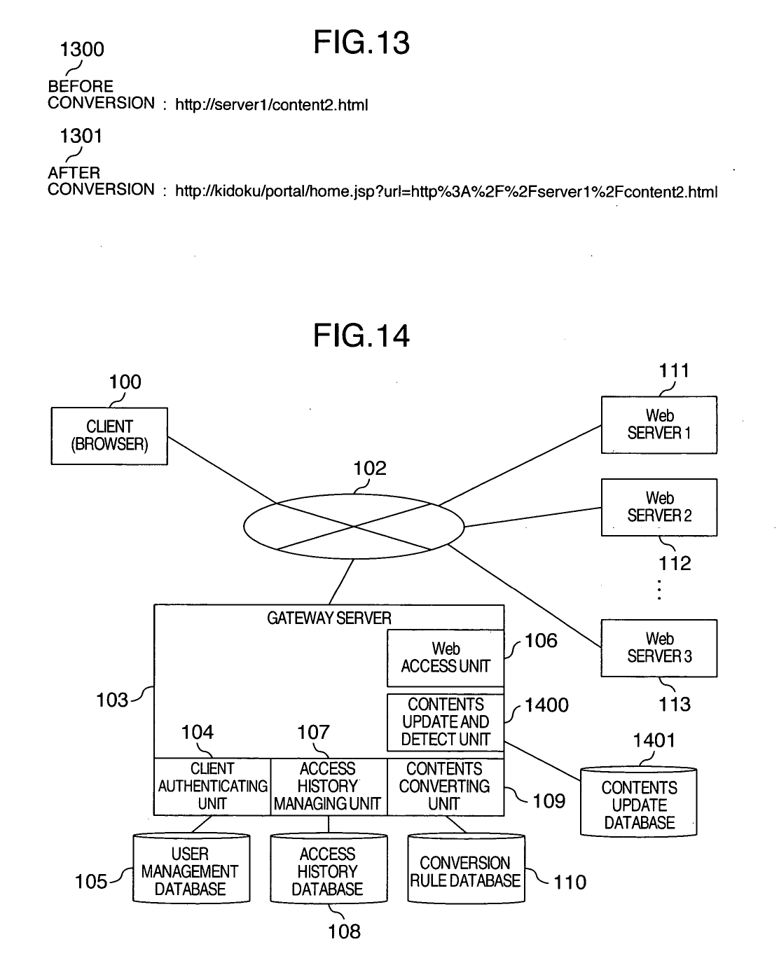

In turn, the parent directory of the URL of the obtained contents is set as the base URL for converting the relative form URL of the contents into the absolute form URL (601). However, if the BASE tag is included in the contents, the base URL is changed into the URL specified by the href attribute of the BASE tag (603). Then, about all the A tags included in the BODY tag of the contents, the display form conversion of the link and the URL conversion are carried out (604, 605). At first, the URL is extracted from the href attribute of the A tag. If the URL takes a relative path form, the relative path form URL is converted into the absolute path form URL based on the base URL (606). Then, it is checked if the extracted URL is included in the access history database 105 (607). If it is included, the CSS information obtained in the step 600 is added to the style attribute of the A tag. If the property matched to the CSS information has been already included in the A tag, the obtained CSS information is overwritten on the A tag (608). Then, the URL specified by “href” is converted into the form of URL+query of the gateway server and then the href attribute is rewritten so that the URL may be passed through the gateway server 103 when the user clicks the A tag (1200). The URL is encoded as shown in FIG. 13. These series of processes result in converting the display form of the URLs located in the access history database 105 and included in the URLs of the contents, that is, the accessed URLs into the display form specified by the conversion rule database 110. Further, when the user clicks the link of the contents, the linked contents are obtained through the gateway server 103.

### Third Embodiment

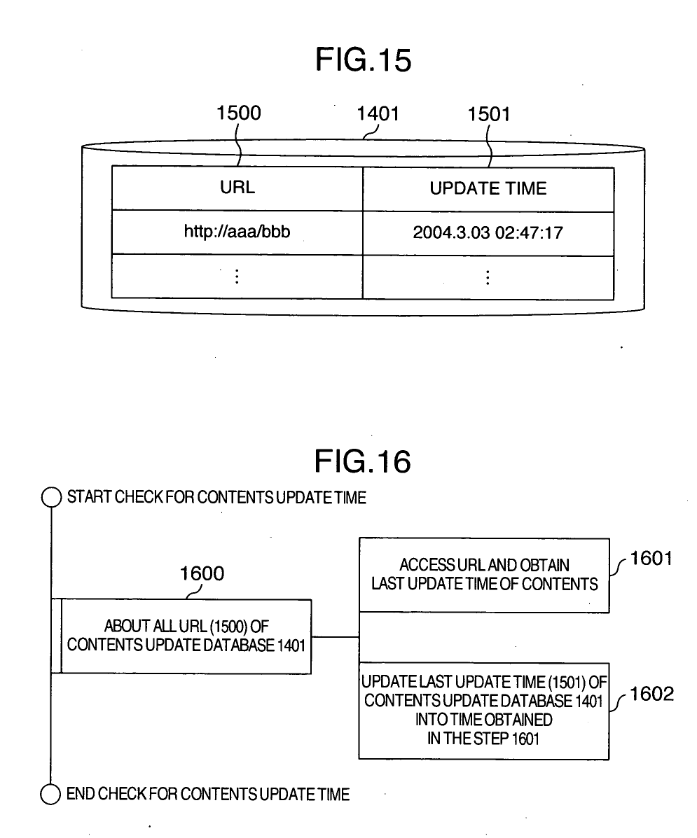

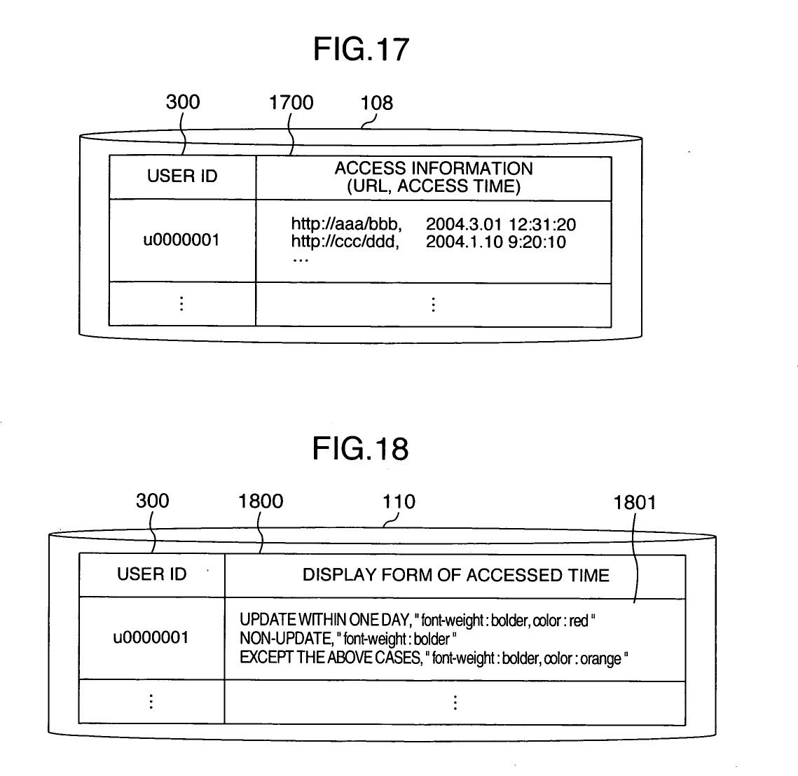

In turn, the description will be turned to the third embodiment of the present invention. In the third embodiment, as shown in FIG. 14, a contents update and detect unit 1400 and a contents update database 1401 are newly added to the gateway server 103 so that the accessed information with the updated contents added thereto may be shown to the user. FIG. 15 shows the composition of the contents update database 1401 for storing an update time of the contents. This database is composed of a URL (1500) of the contents and a field (1501) for storing an update time of the contents. The process of checking the update time of the contents shown in FIG. 16 is periodically called by the contents update and detect unit 1400 so that this process allows this database to update the update time of the contents. About all the URLs of the contents update database 1401 (1600), the process of checking the update time of the contents is executed to access the Web server and obtain the contents update time (1601) and then updates the last update time field (1501). Further, the access history database 108 is expanded so that the time when the user accesses the contents may be stored in the database as indicated by 1700 of FIG. 17.

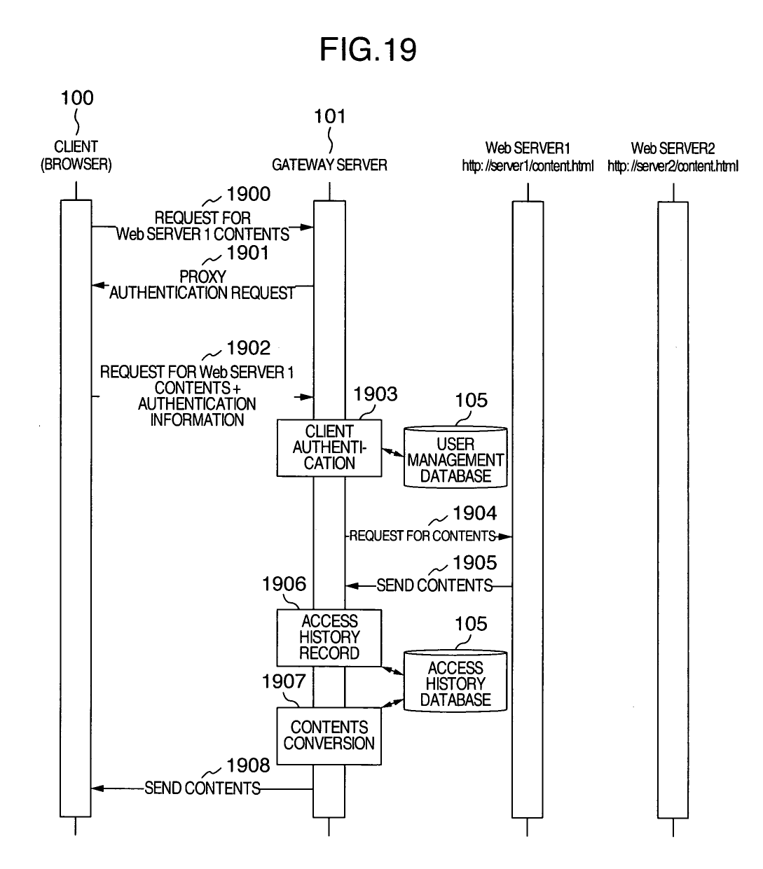

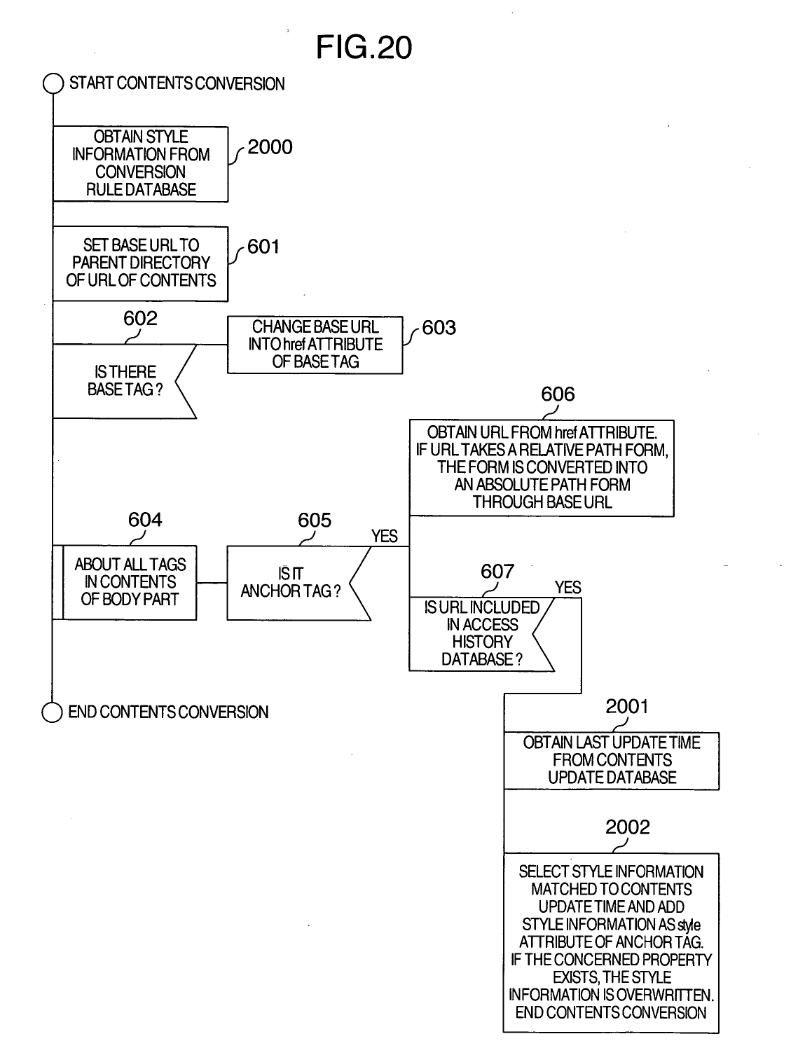

Further, the conversion rule database 110 is expanded so that the update time is added to the condition of the display form as indicated by 1800 of FIG. 18. This embodiment is arranged to change the display form so that in a case that the data is updated within one day, the label of the A tag is written in bold and red characters, in a case that the data is not updated, the label of the A tag is written in bold characters, and excepting these cases, the label of the A tag is written in bold and vermeil characters. The flow of process will be described with reference to FIGS. 19 and 20. The processing sequences 1900 to 1905 of FIG. 19 are likewise to the processing sequences 500 to 505 of FIG. 5. In the processing sequence 1905, the process is executed to obtain the contents from the Web server 1 and record the access history. As mentioned above, the access time is also stored together with the access history (1906). Then, by referring to the access history database 105, the contents conversion is executed to bury the accessed URLs in the contents obtained from the Web server 1 (1907).

The contents converting process will be described with reference to FIG. 20. At first, the display form of the accessed link is obtained from the conversion rule database 110 (2000). If the user ID is u0000001, three display forms shown by 1801 of FIG. 18 are obtained. Next, the parent directory of the URL of the obtained contents is set as the base URL for converting the relative form URL of the contents into the absolute form URL. However, if the BASE tag is included in the contents, the base URL is changed into the URL indicated by the href attribute of the BASE tag (603). Then, about all the A tags included in the BODY tag of the contents, the process for converting the display form of the link is carried out (604, 605). At first, the URL is extracted from the href attribute of the A tag. If the URL takes a relative path form, the relative path form URL is converted into the absolute path form URL based on the base URL (606). Then, it is checked if the extracted URL is included in the access history database 105 (607). If it is included, the last update time of this URL is obtained from the contents update database 1401 (2001). Then, the process is executed to select the suitable style information to the contents last update time obtained in the step 2001 from the CSS information obtained in the step 2000 and then add the style information to the style attribute of the A tag. If the property matched to the CSS information has been already included, the style information is overwritten on the style attribute of the A tag. These series of processes make it possible to show to the user the URLs located in the access history database 105, that is, the accessed URLs in the form of adding the contents update time. In the foregoing description, the third embodiment has been configured so that the gateway server 103 is operated as the proxy server of the client 100. Like the foregoing second embodiment, the third embodiment may be realized in the form of rewriting the URL and relaying the rewritten URL.

### Fourth Embodiment

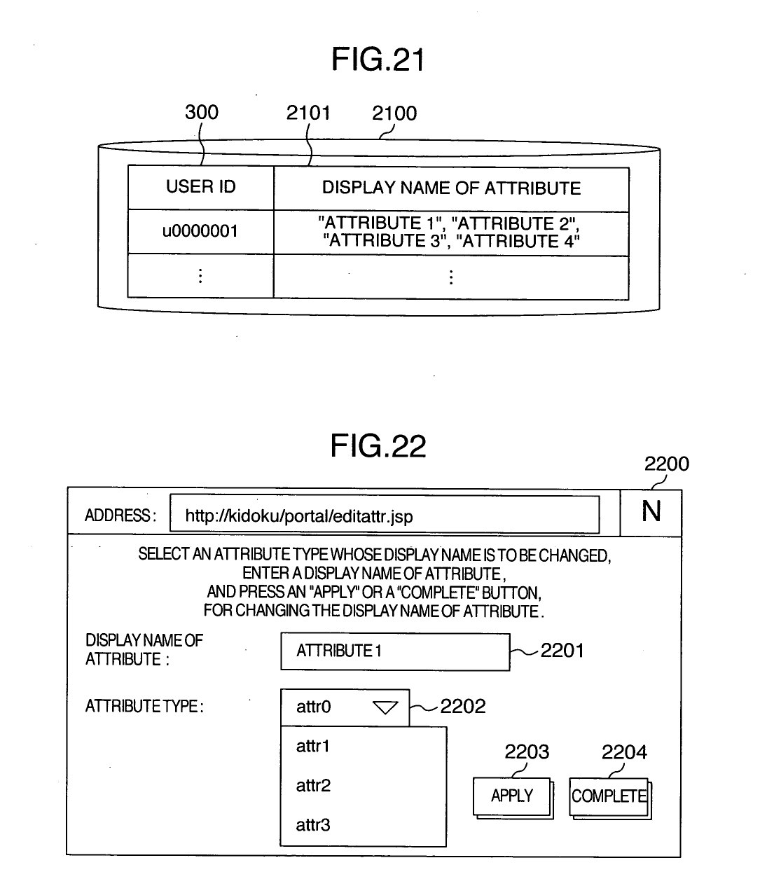

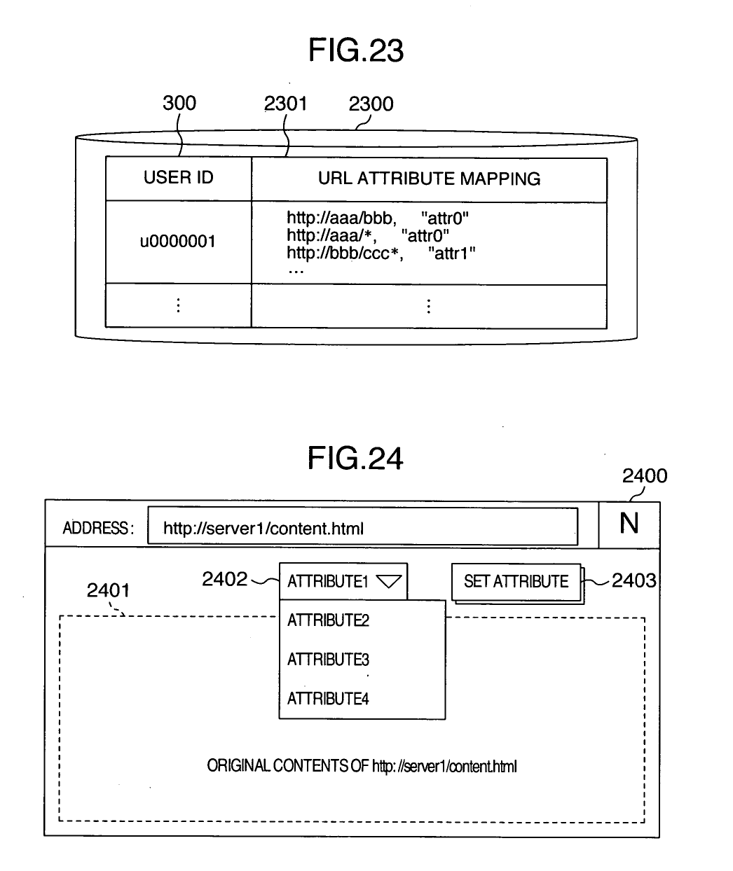

In turn, the description will be turned to the fourth embodiment of the present invention. The fourth embodiment is configured to allow a user to add an attribute such as significance to the URL, if the URL exists in the contents, convert the display form of the link through the display form set for each attribute, and then to show the attribute to the user. The fourth embodiment newly provides a definition database 2100 for display name of attribute type shown in FIG. 21 and an attribute mapping database 2300 shown in FIG. 23. The definition database 2100 for display name of attribute type is a table in which defined is mapping of the display name of attribute displayed by a client against the attribute type ID allocated to the contents. In this embodiment, four attribute type IDs, “attr0”, “attr1”, “attr2” and “attr3” are defined. This means that the user may set four attributes to the contents. Though four attribute type IDs are defined in this embodiment, in actual, the number of the attribute type IDs is optional. The attribute mapping database 2300 is a table in which the correspondence between the URL and the attribute type ID is stored. As a mapping method, two methods are provided, that is, a one-to-one allocation of the absolute form URL to the attribute type ID and an allocation of an attribute type ID to a partial URL through the use of an asterisk. The latter allocation method makes it possible to define mapping between the URL and the attribute type ID by a forward match and a backward match against the URL fragment in the combination of the asterisk with the URL fragment. The exemplary interface for setting a display name of attribute is shown in FIG. 22. The user selects the attribute type ID whose display name is to be set (2202), enters the display name of attribute (2201), and presses an “apply” (2203) or a “complete” (2204) button. These series of operations allow the display name to be set to the attribute ID. Ordinarily, the user sets the attribute to the contents (URL) with this display name.

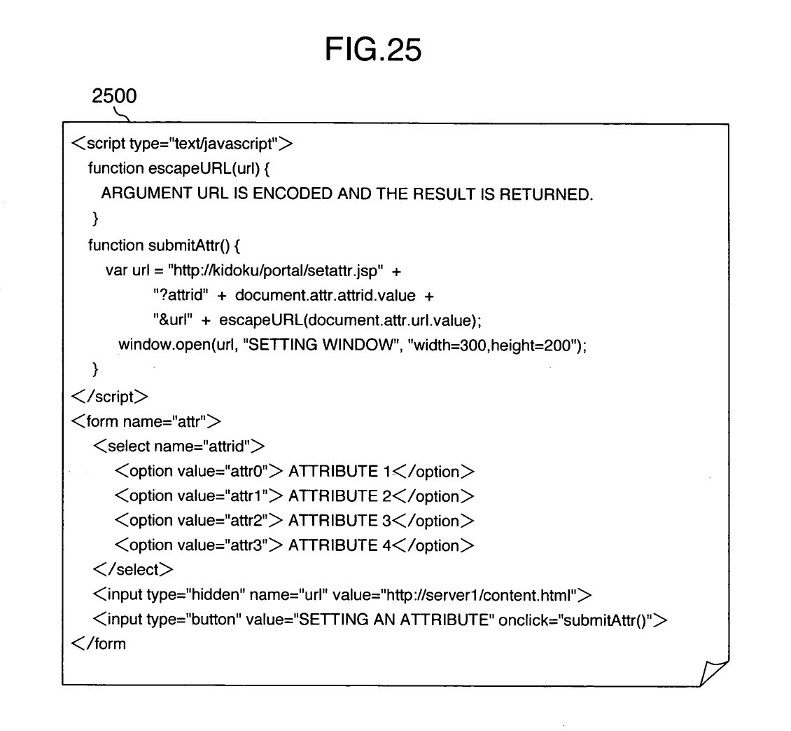

The exemplary interface for setting an attribute to the contents is shown in FIG. 24. This interface screen is created by adding a HTML fragment for setting an attribute type to the contents shown in FIG. 25 when the gateway server 103 sends the contents to the client 100 (in the processing step 508 of FIG. 5, the processing step 811 of FIG. 8 and the processing step 1908 of FIG. 19). The attribute name displayed in an attribute type list 2402 shown in FIG. 24 is made to be the display name of attribute set on the display name of attribute setting interface by the user. If the user would like to set the attribute type to the currently displayed contents, the user may set the attribute type by selecting the attribute type on the attribute type list 2502 and pressing an “attribute setting” button (2403). When the “attribute setting” button (2403) is pressed, the attribute type ID and the target URL are notified to the gateway server 103 according to the HTML fragment of FIG. 25. In this embodiment, the different parent window from the window of the contents is opened so that the server is requested to set the attribute. The gateway server 103 having accepted the request for setting the attribute operates to update the corresponding URL attribute mapping (2301) with the user ID (300) of the attribute mapping database 2300. Then, the gateway server 103 operates to return a message of completing the setting to the parent window.

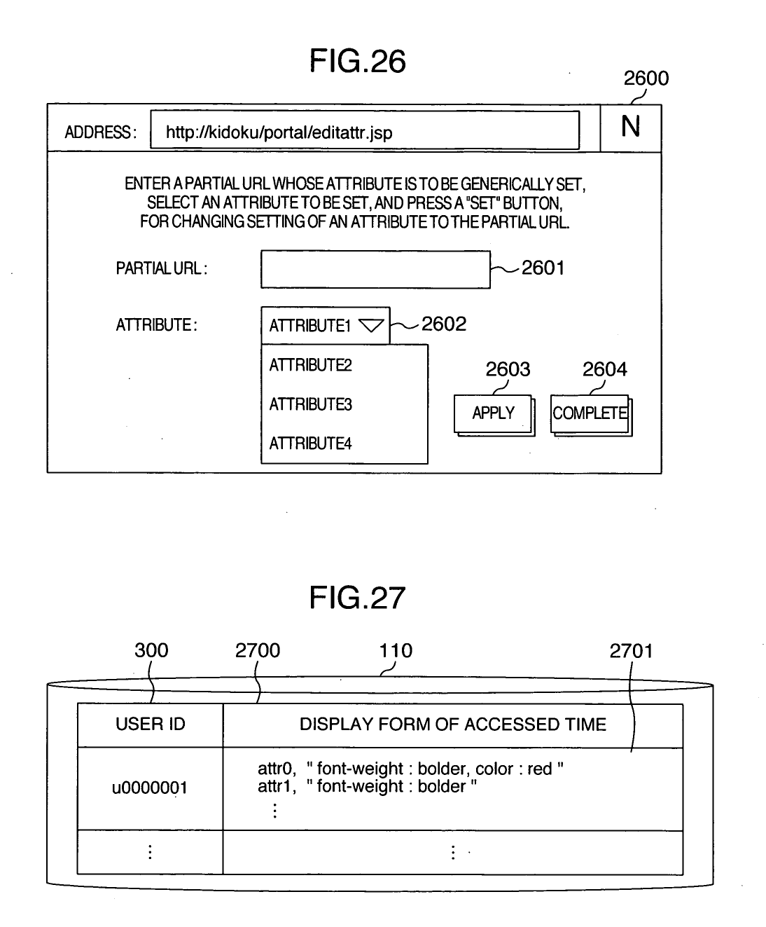

FIG. 26 shows an exemplary interface for setting an attribute type to the partial URL. The user enters a partial URL in a partial URL input area 2601 with an asterisk, selects an attribute type to be set (2602), and presses an “apply” (2603) or a “complete” (2604) button. These operations are executed to issue a request for setting an attribute to the gateway server 103. Like the setting of the attribute to the individual contents, the gateway server 103 updates the corresponding URL attribute mapping (2301) with the user ID (300) of the attribute mapping database 2300.

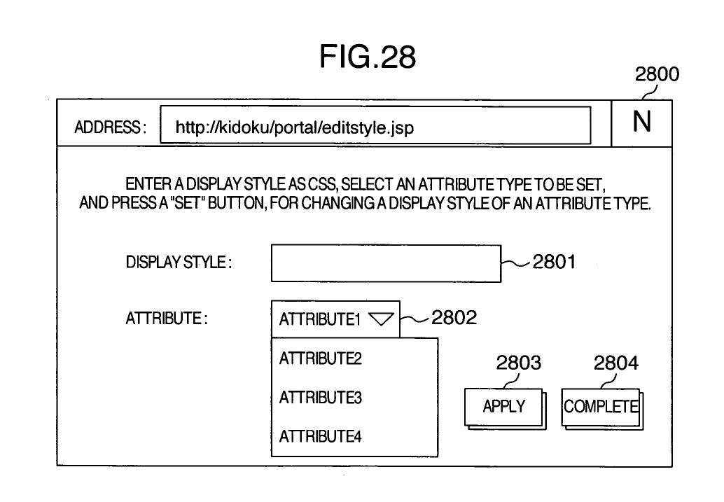

In this embodiment, the conversion rule database 110 has a more expanded table structure than the table structure of the first embodiment shown in FIG. 4. That is, as shown in FIG. 27, a column 1800 of an accessed time display form, which is set to the user ID 300, is divided according to the attribute types. The display style may be stored in correspondence with the set attribute. Further, the exemplary interface for setting the display style to this attribute type is shown in FIG. 28. The user selects an attribute type whose display style is to be set from an attribute type list, note the selected type on the column 2802, enters the display style as the CSS on the column 2801, and presses an apply button 2803 or a complete button 2804. These operations complete the setting of this correspondence.

### Fifth Embodiment

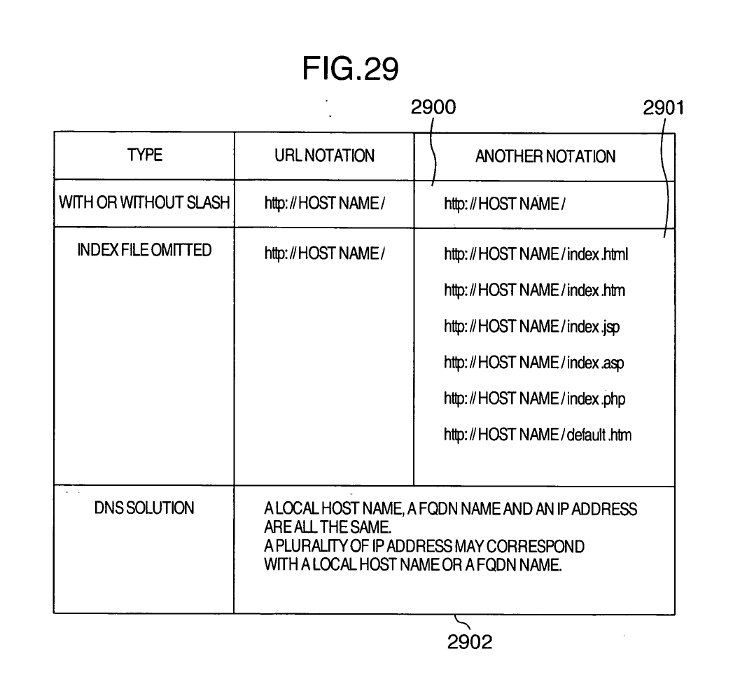

In turn, the description will be turned to another notation of a URL according to the fifth embodiment of the present invention. As shown in FIG. 29, if the URLs have different typefaces from each other, those URLs may have the same contents. For example, if the URL has a slash at its end, it indicates the same contents as the URL without a slash at its end (2900). Further, the URL with a slash at its end indicates the same contents as the index file located in the Web server that is the index of the virtual directory. The index file is “index.html”, “index.htm”, “index.jsp”, “index.asp”, “index.php”, “default.htm”, and so forth, which are specified according to the type and the setting of the Web server (2901). Further, considering the DNS, though the DNS has the different typefaces such as a local host name, a FQDN name and an IP address, if the mapping on the same server is executed through the DNS, the DNS indicates the same contents despite of the different URL notations. In addition, in the case of using the DNS round robin, a plurality of IP addresses may correspond with a local host name and a FQDN name. Also in this case, those IP addresses indicate the same contents (2902).

In the fifth embodiment, therefore, the URL matching process caused when determining if the URL has been accessed is executed to obtain a candidate list of a host name and an index file name that may have another name through the URL normalization. This candidate list is used when determining if the URL has been accessed. Hereafter, the normalization will be described.

The normalization is composed of two parts, that is, a host name and an index file name. If the index file name of the URL to be normalized is empty, the index file candidate list (to be discussed below) is a normalized result (3002). On the other hand, if the index file name has some name, the normalization is executed to send a HTTP request to the Web server. If the response from the server is a redirect request to the URL with a slash at its end, like the processing step 3002, the index file candidate list is made to be a normalized result. If no redirect request is issued, the file itself is made to be the index file. Hence, the index file name to be normalized is made to be the normalized result as it is.

The process for the host name is executed to obtain an IP address list through the use of the DNS. The IP address list is made to be the normalized result. Concretely, if the host name to be normalized was an IP address, the process is executed to obtain the host name from the IP address through the DNS and obtain the IP address list through the host name again. The IP address list is made to be the normalized result (3008).

The URL matching process is executed to determine if the URL has been already accessed by using a list of index file names and a list of IP address of the Web server that may indicate the same URL, those lists being obtained by the normalization.

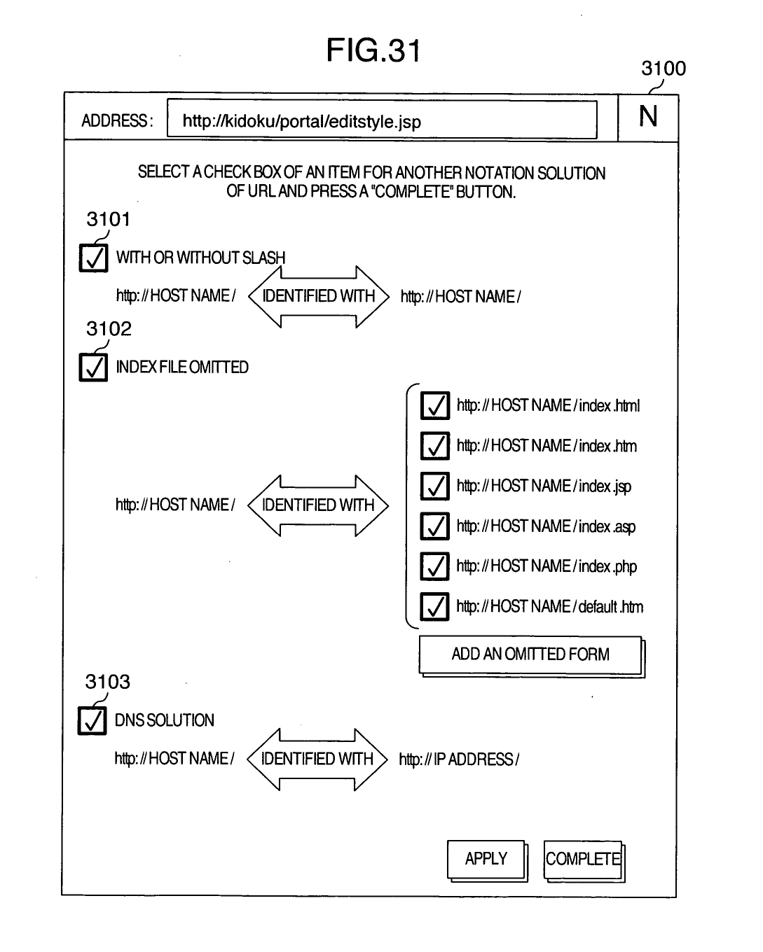

In turn, the description will be turned to the method of defining an index file candidate list with reference to FIG. 31. The present interface prompts the user to select the file names that may indicate the same URL as an index file (3102). The index file name list selected by the user is used for the foregoing normalization. A check box (3101) with or without slash or a DNS resolve check box (3103) with or without slash indicates whether or not the processes of the steps 3004 and 3006 in the normalization are executed. Further, a system administrator may set a default value of the foregoing setting. The foregoing operation makes it possible to manage the accessed URLs with different name notations.

### Sixth Embodiment

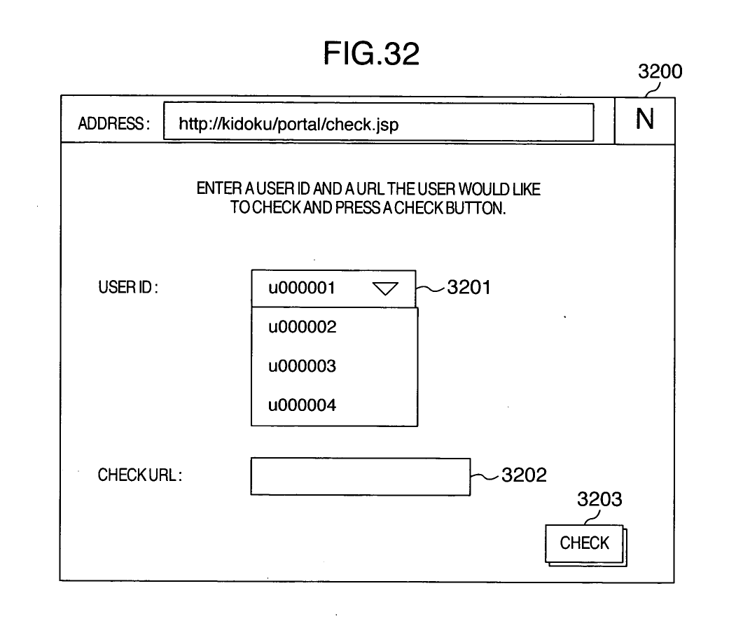

In turn, the description will be turned to the feature of checking the accessed information of another user according to the sixth embodiment of the present invention. This feature makes it possible to check if another user refers to the contents. FIG. 32 shows the exemplary interface for checking. As shown, when a person enters an ID (3201) of a user to be checked and a URL (3202) to be checked and presses a check button (3203), the person enables to check if the target user refers to the target URL.

In this embodiment, an access history managing unit 107 provides a means of retrieving the access history database 108 through the use of the user ID and the URL specified on the interface screen and then giving back the retrieved result.

The access history database 108 may further include a composition shown in FIG. 17, that is, a table in which the access information and the access time of the URL are recorded. By referring to this access history database 108, it is possible to obtain the time when the specified user refers to the contents.

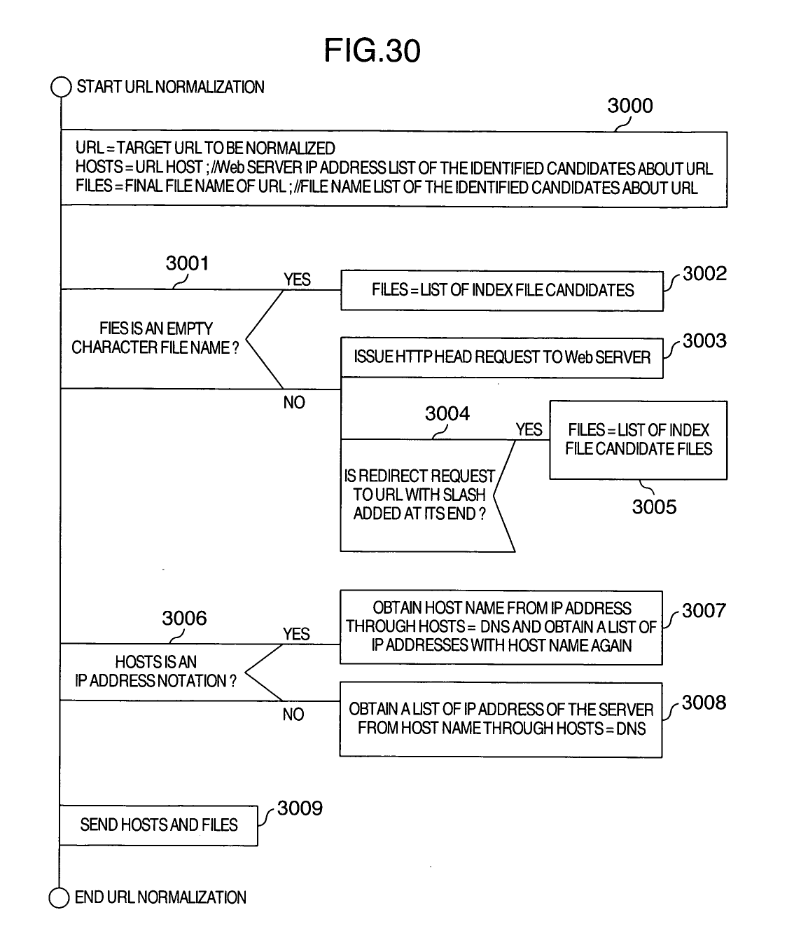

Another notation of the URL having been described with reference to FIGS. 29 and 30 may be used for the foregoing retrieval, that is, the retrieval as to whether or not another user has already accessed the contents.

Though the exemplary interface prompts a person to select one user, the interface may be rearranged so that two or more users may be selected at a time. Further, about a list of user IDs to be checked, it is also possible to check only a list of colleagues in association with LDAP.

According to this embodiment, it is possible to check if another user refers to the contents. This makes it possible to check if another user has already read the important information.

The present invention allows the gateway server to generically manage the accessed information. The invention thus provides a service of managing the accessed information in a ubiquitous environment, which makes it possible to improve the user's efficiency of accessing Webs.

It should be further understood by those skilled in the art that although the foregoing description has been made on embodiments of the invention, the invention is not limited thereto and various changes and modifications may be made without departing from the spirit of the invention and the scope of the appended claims.

1. A method of managing access to Web pages, comprising the steps of:
(a) causing a gateway server to accept a login request of a client;
(b) authenticating said client through a client authentication feature and having a session with said authenticated client;
(c) accepting a request for obtaining contents from a Web browser of said client;
(d) obtaining the contents from a requested Web server in response to said accepted request;
(e) recording a URL accessed in said step (d) in an access history database as an access history of said client;
(f) determining if said client has already accessed a link included in the contents obtained in said step (d) by referring to said access history database and, if said link has been already accessed, changing a display form of said link by referring to a conversion rule database for storing the display form of said accessed link, and
(g) sending said changed contents to said client, thereby the client is provided with a service of managing access to Web pages through a gateway server for obtaining the contents from a Web server in place of a Web browser of said client.

2. A method of managing access to Web pages as claimed in claim 1, further comprising a step of cyclically checking if the contents are updated about the link said client has accessed by referring to said access history database, and wherein the change of the display form of said link in said step (f) is the change of the display form specified according to the update time of said contents.

3. A method of managing access to Web pages as claimed in claim 1, wherein when said contents are sent to said client in said step (g), an attribute setting interface for prompting a user to set an attribute of a user's definition of said contents according to an URL of said contents is added to said contents and then said contents with said interface added are sent, said conversion rule database stores a display form of the link selected by said user in correspondence with an attribute of the contents set by said user, and if an attribute of the link contained in said obtained contents has been set in said step (f), a display form for said attribute is selected by referring to said conversion rule database and said contents are converted according to the selected display form.

4. A method of managing access to Web pages as claimed in claim 3, wherein said attribute setting interface further includes an interface for prompting a user to set a partial URL composing a part of the URL of said contents to be sent to said client and an attribute for said partial URL.

5. A method of managing access to Web pages as claimed in claim 1, wherein said attribute setting interface further includes an interface for prompting a user to define if another notation of the URL is identified as the original notation when determining that the contents have been accessed, and in said step (f), a matching process for the original and another notations of the URL is carried out about the link included in said obtained contents, for determining if said contents have been already accessed.

6. A system of managing access to Web pages, comprising:
a user management database for managing a user ID and a password;
a client authenticating unit for user-authenticating a requesting client through the use of said user management database if a login request is received from said client;
an access history database for storing at least a list of accessed URLs as a Web page access history of said client;
a Web access unit for obtaining the contents from said Web server in response to a request for obtaining the contents from said client;
a conversion rule database for storing the contents display form in correspondence with at least user's ID if the link of said contents has been already accessed;
an access history managing unit for recording the URL of the contents obtained by said Web access unit in said access history database; and
a contents converting unit for converting a contents display form of said URL into a display form stored in said conversion rule database if said URL has been already located in said access history database.

7. A system of managing access to Web pages as claimed in claim 6, wherein said access history managing unit includes retrieval means of accepting a specification of a user ID and a URL to be checked if said user has already accessed said URL and retrieving if said specified URL is included in a list of accessed URLs for said user ID in said access history database.
